(19) United States
(12) Patent Application Publication
(10) Pub. No.: US 2015/0017829 A1
(43) Pub. Date: Jan. 15, 2015

(54) CONNECTION STRUCTURE OF BRAIDED-SHIELD-TYPE ELECTRIC WIRE AND METHOD FOR MANUFACTURING SHIELD ELECTRIC WIRE HARNESS

(71) Applicant: FUJIKURA LTD., Tokyo (JP)

(72) Inventors: Kohki Ishikawa, Sakura-shi (JP); Isamu Yatougo, Tokyo (JP)

(73) Assignee: FUJIKURA LTD., Tokyo (JP)

(21) Appl. No.: 14/498,779

(22) Filed: Sep. 26, 2014

Related U.S. Application Data
(63) Continuation of application No. PCT/JP2013/058716, filed on Mar. 26, 2013.

(30) Foreign Application Priority Data
Mar. 26, 2012 (JP) 2012-069582

(51) Int. Cl. H01R 13/58; H01R 13/52; H01R 13/648

(52) U.S. Cl. CPC H01R 13/58; H01R 13/648; H01R 13/5221
USPC 439/460; 29/825

(57) ABSTRACT

A connection structure of a braided-shield-type electric wire for connecting the braided-shield-type electric wire including a plurality of sheathed electric wires and a braided shield member surrounding the sheathed electric wires to a connector and for electrically connecting the braided shield member to a shield shell in a connector housing, the connection structure comprising: a retainer that is arranged inside the braided shield member to hold the sheathed electric wires in a slidable state; a first annular conductive member that is fitted to an outer peripheral side of the retainer in a state where the braided shield member is sandwiched therebetween; and a second annular conductive member that is fitted to an outer peripheral side of the first annular conductive member in a state where the braided shield member is sandwiched therebetween.

### CROSS-REFERENCE TO RELATED APPLICATIONS

This application is a continuation application of PCT Application No. PCT/JP2013/58716, filed on Mar. 26, 2013, which is based on and claims the benefit of priority from prior Japanese Patent Application No. 2012-69582, filed on Mar. 26, 2012, the entire contents of which are incorporated herein by reference.

### BACKGROUND OF THE INVENTION

1. Field of the Invention

The present invention relates to a connection structure of a braided-shield-type electric wire and a method for manufacturing a shield electric wire harness for connecting the braided-shield-type electric wire including a braided shield member surrounding sheathed electric wires to a connector.

2. Description of the Prior Art

In the related art, in the case of connecting a braided-shield-type electric wire of a form in which sheathed electric wires are surrounded by a braided shield member to a connector, a connection is performed by a terminal structure as disclosed in Japanese Unexamined Patent Application Publication No. 2005-294246 A described below. That is, when the braided shield member is attached to a shield shell surrounding a terminal fitting attached to the braided-shield-type electric wire in a connector housing, a pair of metallic annular conductive members, which can be fitted to each other, are used, and the braided shield member is sandwiched and fixed by caulking between these annular conductive members.

Then, by fitting an end terminal portion of the braided shield member which is formed by caulking fixation to the shield shell in the connector housing, the braided shield member and the shield shell are electrically connected to each other and the braided-shield-type electric wire is connected to the connector.

### SUMMARY OF THE INVENTION

However, in the terminal structure of the related art disclosed in Japanese Unexamined Patent Application Publication No. 2005-294246 A described above, when the annular conductive members are mounted at a leading end in the end terminal direction of the braided shield member, there is a case where a sheathed electric wire is caught in the braided shield member or the braided shield member is loosened and caught in the annular conductive member. In this case, there has been such a problem that workability becomes very poor.

The present invention solves the problems in the related art described above and an object of the present invention is to provide a connection structure of a braided-shield-type electric wire and a method for manufacturing a shield electric wire harness which can achieve very good workability.

In a connection structure of a braided-shield-type electric wire according to an embodiment of the present invention for connecting the braided-shield-type electric wire including a plurality of sheathed electric wires and a braided shield member surrounding the sheathed electric wires to a connector and for electrically connecting the braided shield member to a shield shell in a connector housing, the connection structure includes: a retainer that is arranged inside the braided shield member to hold the sheathed electric wires in a slidable state; a first annular conductive member that is fitted to an outer peripheral side of the retainer in a state where the braided shield member is sandwiched therebetween; and a second annular conductive member that is fitted to an outer peripheral side of the first annular conductive member in a state where the braided shield member is sandwiched therebetween, and the braided shield member is sandwiched and fixed between the retainer and the first annular conductive member at a position behind a leading end of an end terminal portion and is also sandwiched and fixed by caulking between the first and second annular conductive members after being folded backward from a leading end side of the first annular conductive member.

According to the connection structure of the braided-shield-type electric wire according to an embodiment of the present invention, since there is provided the structure in which the plurality of sheathed electric wires provided inside the braided shield member is held by the retainer, the braided shield member is sandwiched and temporarily fixed between the retainer and the first annular conductive member, and the braided shield member is folded to be sandwiched and fixed by caulking between the first and second annular conductive members, the free movement of the sheathed electric wires is suppressed by the retainer, the braided shield member is also prevented from being pulled by the sheathed electric wires because the braided shield member is temporarily fixed, and it is possible to perform the caulking fixation without worrying about the state of the braided shield member.

In addition, since the braided shield member is folded to be sandwiched and fixed by caulking between the first and second annular conductive members, the braided shield member is prevented from slipping out of the first and second annular conductive members and is also prevented from being short-circuited by contacting a part of the braided shield member with a terminal fitting or the like. Further, since the retainer is arranged inside the first annular conductive member, the retainer can function as a supporting member during the caulking fixation and it is possible to prevent unnecessary deformation of the first and second annular conductive members.

In another embodiment of the present invention, the shield shell and the second annular conductive member are connected to each other in a state where the end terminal portion of the braided shield member is fitted into the connector housing, and thus the end terminal portion of the braided shield member is electrically connected to the shield shell.

In yet another embodiment of the present invention, the retainer and the first annular conductive member each include an engaging portion and a portion to be engaged that are engaged with each other. Thus, the first annular conductive member can be firmly fixed to the retainer, and it is possible to firmly and temporarily fix the braided shield member sandwiched between the retainer and the first annular conductive member.

In yet another embodiment of the present invention, the retainer has an external shape that is matched to a shape of an inner peripheral surface of the first annular conductive member and that has a recess portion formed at a predetermined location, and the first and second annular conductive members are deformed in being matched to the recess portion to be fixed by caulking. Thus, the first and second annular conductive members can be fixed by caulking without deforming the overall shapes thereof.

In still another embodiment of the present invention, the retainer includes a plurality of electric wire insertion holes into which the plurality sheathed electric wires can be individually inserted. Thus, it is possible to individually hold each of the plurality of sheathed electric wires.

In still another embodiment of the present invention, the retainer includes a plurality of tubular portions that is protruded and formed so as to arrange one sides of openings of the plurality of electric wire insertion holes at the leading end side in the end terminal direction, and the plurality of tubular portions is housed in terminal housing holes formed in the connector housing, respectively, and also includes a first seal member provided at an outer peripheral side and a second seal member provided in an electric wire insertion hole on an inner peripheral side. Thus, it is possible to improve the waterproof of each sheathed electric wire in the connector.

In still another embodiment of the present invention, the retainer includes a fitting main body portion that is externally fitted to the first annular conductive member at the outer peripheral side and a tapered portion that protrudes from the fitting main body portion so as to be tapered along an axial direction of the braided-shield-type electric wire. Thus, the retainer can be easily inserted inside the braided shield member.

In still another embodiment of the present invention, the plurality of electric wire insertion holes are formed such that an arrangement pitch of an opening on the tapered portion side is narrower than an arrangement pitch of an opening on the fitting main body portion side. Thus, the plurality of the sheathed electric wires can be further easily inserted into each of the electric wire insertion holes of the retainer.

In a method for manufacturing a shield electric wire harness according to an embodiment of the present invention for connecting a braided-shield-type electric wire including a plurality of sheathed electric wires and a braided shield member surrounding the sheathed electric wires to a connector and for electrically connecting the braided shield member to a shield shell in a connector housing, the method includes steps of: cutting the braided-shield-type electric wire so as to expose the braided shield member; inserting a retainer, in which a plurality of electric wire insertion holes is formed, to outer peripheral sides of the plurality of sheathed electric wires and inside the braided shield member and holding a plurality of sheathed electric wires inserted into the plurality of electric wire insertion holes by the retainer; surrounding an outer peripheral side of the retainer by the braided shield member and also arranging a leading end in an end terminal direction of the braided shield member at a more front side than the retainer in the end terminal direction; externally fitting a first annular conductive member to the outer peripheral side of the retainer in a state where the braided shield member is interposed and sandwiching and fixing the braided shield member between the retainer and the first annular conductive member; folding the leading end in the end terminal direction of the braided shield member which is arranged at the front side in the end terminal direction; externally fitting a second annular conductive member to an outer peripheral side of the first annular conductive member in a state where the folded braided shield member is interposed, sandwiching and fixing the braided shield member by caulking between the first and second annular conductive members, and forming an end terminal portion of the braided shield member; and fitting the end terminal portion of the braided shield member to the connector housing and connecting the second annular conductive member to the shield shell after connecting terminal fittings to end terminal portions of the plurality of sheathed electric wires and inserting each of the terminal fittings into the connector housing.

According to the method for manufacturing the shield electric wire harness according to an embodiment of the present invention, the plurality of sheathed electric wires provided inside the braided shield member are held by the retainer, the braided shield member is sandwiched and temporarily fixed between the retainer and the first annular conductive member, and then the braided shield member is folded to be sandwiched and fixed by caulking between the first and second annular conductive members. Thus, it is possible to manufacture the shield electric wire harness for realizing the above operational effects.

In another embodiment of the present invention, the method includes a step of mounting the first annular conductive member at an outer peripheral side of the braided shield member so as to be put on standby at a rear side in the end terminal direction, prior to the step of holding the plurality of sheathed electric wires by the retainer, and in the step of sandwiching and fixing the braided shield member, the first annular conductive member being put on standby is moved to a front side in the end terminal direction and is externally fitted to the outer peripheral side of the retainer such that the braided shield member is sandwiched therebetween.

### BRIEF DESCRIPTION OF THE DRAWINGS

FIG. 1 is an exploded perspective view of a shield electric wire harness for illustrating a connection structure of a braided-shield-type electric wire according to an embodiment of the present invention.

FIG. 2 is a partially enlarged perspective view of FIG. 1.

FIG. 3 is a cross-sectional view of the same shield electric wire harness.

FIG. 4 is a flowchart illustrating manufacturing steps according to a method for manufacturing a shield electric wire harness according to an embodiment of the present invention.

FIG. 5A is a cross-sectional view for each manufacturing step of the shield electric wire harness according to the same manufacturing method.

FIG. 5B is a cross-sectional view for each manufacturing step of the shield electric wire harness according to the same manufacturing method.

FIG. 5C is a cross-sectional view for each manufacturing step of the shield electric wire harness according to the same manufacturing method.

FIG. 5D is a cross-sectional view for each manufacturing step of the shield electric wire harness according to the same manufacturing method.

FIG. 5E is a cross-sectional view for each manufacturing step of the shield electric wire harness according to the same manufacturing method.

FIG. 5F is a cross-sectional view for each manufacturing step of the shield electric wire harness according to the same manufacturing method.

FIG. 6G is a cross-sectional view for each manufacturing step of the shield electric wire harness according to the same manufacturing method.

FIG. 6H is a cross-sectional view for each manufacturing step of the shield electric wire harness according to the same manufacturing method.

FIG. 6I is a cross-sectional view for each manufacturing step of the shield electric wire harness according to the same manufacturing method.

FIG. 7A is an enlarged perspective view of main portions for illustrating a connection structure of a braided-shield-type electric wire according to another embodiment of the present invention.

FIG. 7B is an enlarged perspective view of main portions for illustrating a connection structure of a braided-shield-type electric wire according to another embodiment of the present invention.

The accompanying drawings, which are incorporated in and constitute a part of the specification, illustrate embodiments of the invention, and together with the general description given above and the detailed description of the embodiments given below, serve to explain the principles of the invention.

### DESCRIPTION OF THE PREFERRED EMBODIMENTS

Hereinafter, a connection structure of a braided-shield-type electric wire and a method for manufacturing a shield electric wire harness according to embodiments of the present invention will be described in detail with reference to the accompanying drawings.

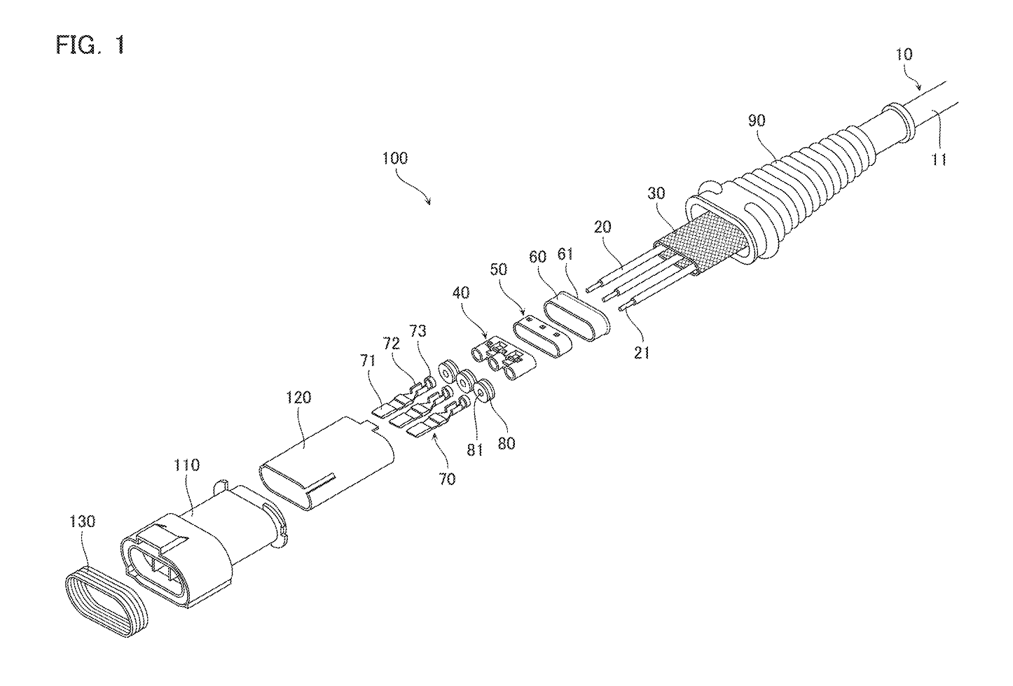

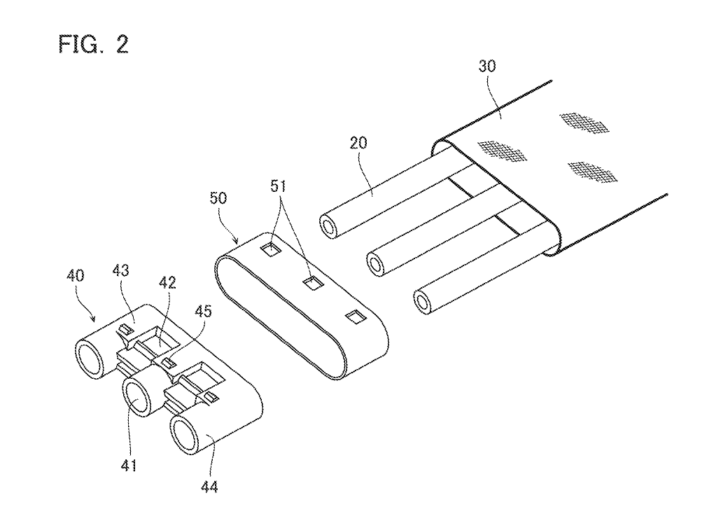

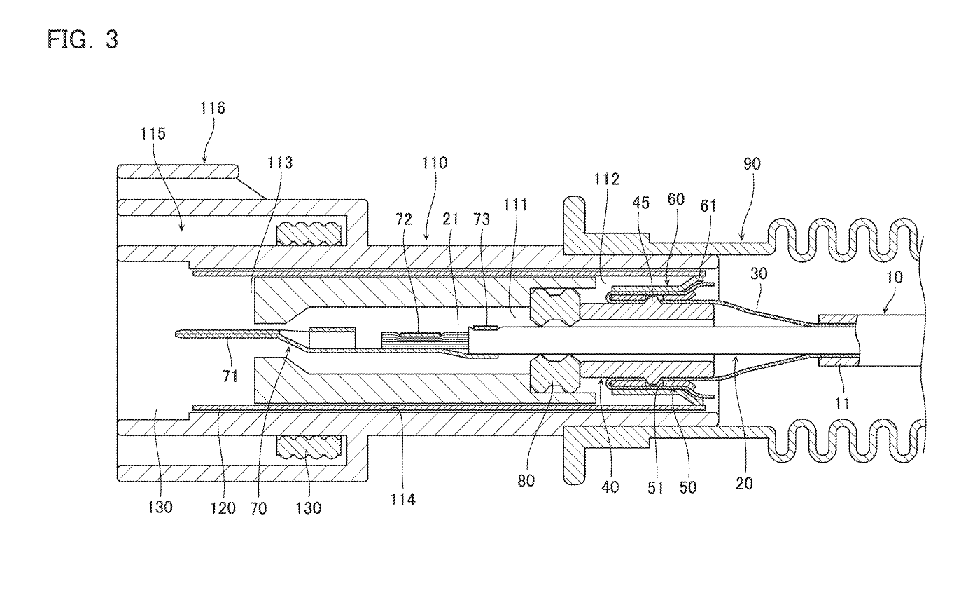

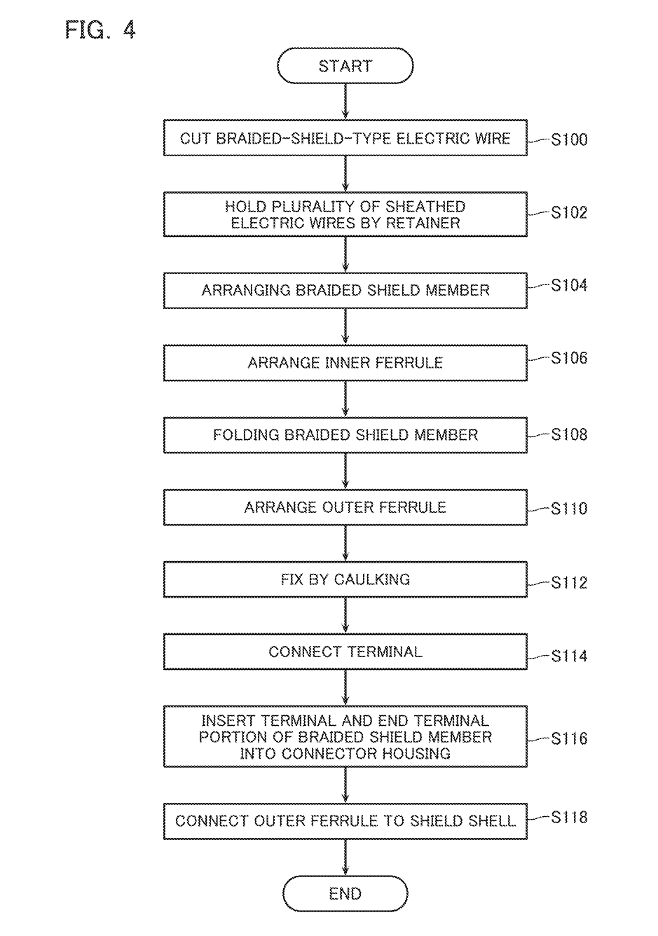

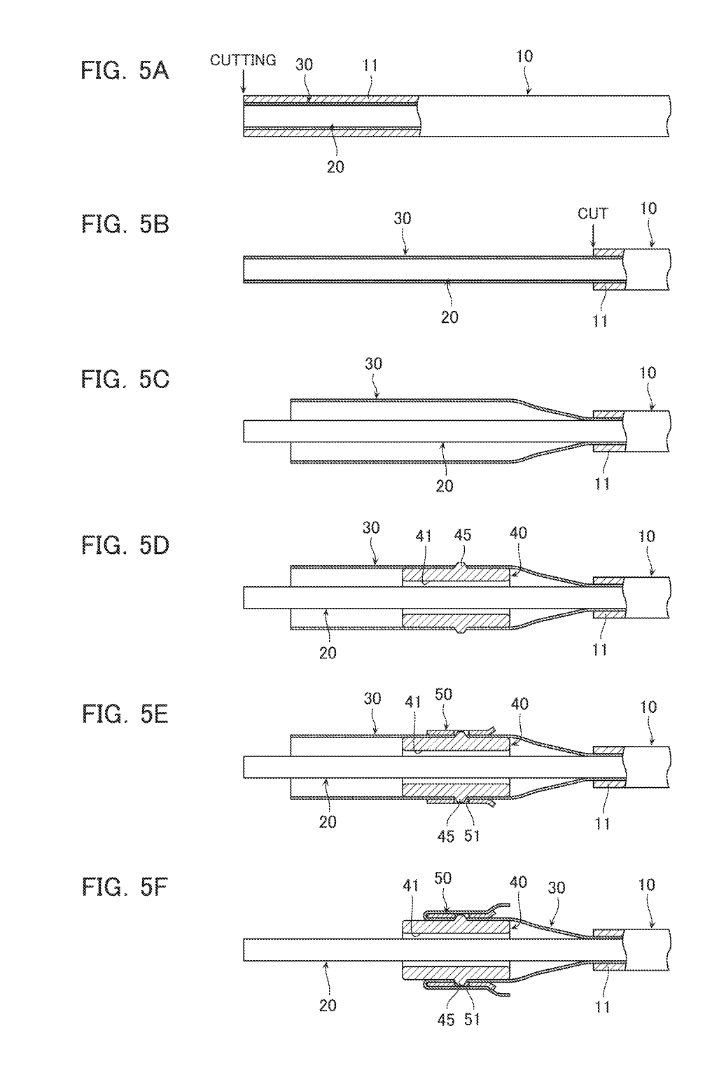

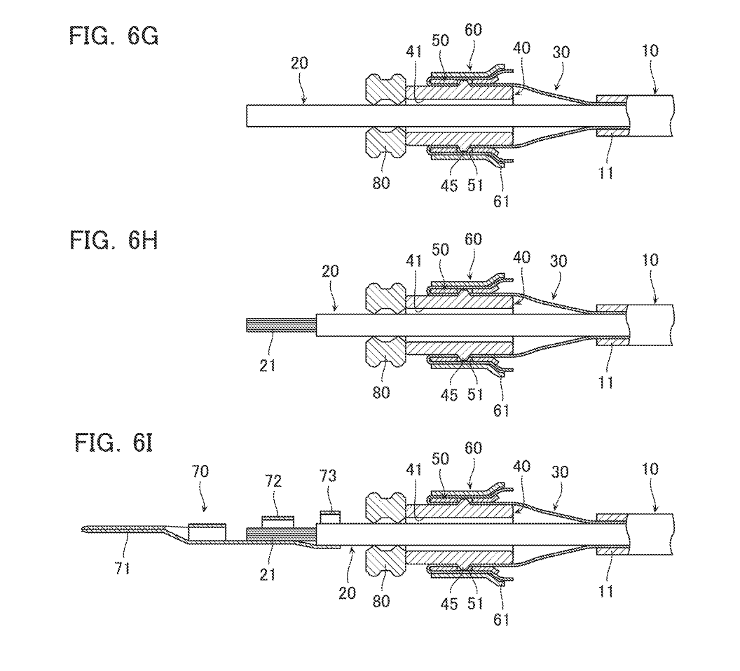

FIG. 1 is an exploded perspective view of a shield electric wire harness for illustrating a connection structure of a braided-shield-type electric wire according to an embodiment of the present invention. FIG. 2 is a partially enlarged perspective view of FIG. 1. In addition, FIG. 3 is a cross-sectional view of the shield electric wire harness. Further, FIG. 4 is a flowchart illustrating manufacturing steps according to a method for manufacturing a shield electric wire harness according to an embodiment of the present invention. In addition, FIGS. 5A, 5B, 5C, 5D, 5E, 5F and FIGS. 6G, 6H, 6I are cross-sectional views for each manufacturing step of the shield electric wire harness according to the manufacturing method.

As illustrated in FIGS. 1 to 3, a shield electric wire harness 100 is configured to include a braided-shield-type electric wire 10 having a braided shield member 30 surrounding a plurality of sheathed electric wires 20 and a connector to be connected to the braided-shield-type electric wire 10, and the connector includes a connector housing 110 made of a resin member and a shield shell 120 made of a metal member.

The braided-shield-type electric wire 10 has a structure in which the sheathed electric wires 20 are each bundled in a center thereof; the braided shield member 30 is arranged at outer peripheral sides of the sheathed electric wires so as to surround the sheathed electric wires; and the outer peripheral side of the braided shield member 30 is further covered by a sheathing member 11. Note that the braided shield member 30 has a structure in which a plurality of thin shielding wires is woven, and is configured to include a reinforcing material (not illustrated) such as plastic which prevents a loss of shape from the woven state.

The braided-shield-type electric wire 10 includes a retainer 40 which is made of a resin member and is arranged inside the braided shield member 30 to hold each of the sheathed electric wires 20 in a slidable state in a core wire direction thereof, an annular inner ferrule 50 which is fitted to an outer peripheral side of the retainer 40 in a state where the braided shield member 30 is sandwiched therebetween, and an annular outer ferrule 60 which is fitted to an outer peripheral side of the inner ferrule 50 in a state where the braided shield member 30 is sandwiched therebetween. Note that the inner ferrule 50 and the outer ferrule 60 are made of a metal member and are fixed to the retainer 40 by caulking.

Accordingly, the braided shield member 30 is sandwiched and fixed between the retainer 40 and the inner ferrule 50 at an end terminal portion thereof and is also sandwiched between the inner ferrule 50 and the outer ferrule 60 and fixed to the retainer 40 by caulking after being folded backward at a leading end side in an end terminal direction of the braided shield member 30.

As illustrated in FIG. 2, the retainer 40 is configured to include a fitting main body portion 43 which is externally fitted to the inner ferrule 50 at the outer peripheral side and a plurality of tubular portions 44 which is protruded from the fitting main body portion 43 and formed. In addition, the retainer 40 includes a plurality of electric wire insertion holes 41 into which the plurality of sheathed electric wires 20 of the braided-shield-type electric wire 10 can be individually inserted.

For example, the retainer 40 is formed to have a shape in which the fitting main body portion 43 is matched to a shape of an inner peripheral surface of the inner ferrule 50, for example, an external shape in which a recess portion 42 is formed at a total of four locations in which two locations are respectively provided at top and bottom sides. An opening at a leading end side in the end terminal direction of each of the electric wire insertion holes 41 is located at a leading end side of the tubular portion 44.

On the other hand, the inner ferrule 50 and the outer ferrule 60 are formed in an annular shape that can be respectively fitted to outer peripheral sides of the retainer 40 and the inner ferrule 50, and engagement holes 51 are formed on the inner ferrule 50 to be engaged with engagement projection portions 45 formed on the outer peripheral surface of the retainer 40. When the engagement holes 51 are engaged with the engagement projection portions 45, the inner ferrule 50 is positioned and attached to the retainer 40.

In addition, a circumferential portion at a rear side in the end terminal direction of the outer ferrule 60 is made as a rib 61 having an outward-rising shape, and has a structure in which the rib 61 comes in contact with the shield shell 120 when being inserted into the connector housing 110 and the shield shell 120 and the braided shield member 30 are electrically connected to each other.

A plurality of ring-shaped wire seals 80, of which hole portions 81 are formed respectively, is provided at a leading end side of the retainer 40 to seal each of the sheathed electric wires 20 while passing in close contact with it. A terminal 70 is, for example, a known crimp-type terminal and is configured to include a connection portion 71 connected to a mating connection terminal, a crimp portion 72 for crimping a core wire 21 of a sheathed electric wire 20, and a pressing portion 73 for pressing the sheathed electric wire 20. The terminal 70 is crimped and attached to a leading end of the core wire 21 of each sheathed electric wire 20 passing through an electric wire insertion hole 41 of the retainer 40 and a hole portion 81 of a wire seal 80.

The connector housing 110 is formed such that the inside thereof includes a terminal housing hole 111 for housing each of the sheathed electric wires 20, an end terminal portion housing hole 112 for housing the end terminal portion of the braided-shield-type electric wire 10 formed at the rear side in the end terminal direction of the terminal housing hole 111, a fitting hole 113 which is formed at the leading end side in the end terminal direction of the terminal housing hole 111 and is fitted to another connector, and a shield shell housing hole 114 for housing the shield shell 120 formed at the same inner surface level as the fitting hole 113 and the end terminal portion housing hole 112.

In addition, the connector housing 110 is formed at the outer peripheral side of the fitting hole 113 in an annular shape and includes a peripheral wall fitting portion 115 to which a peripheral wall of a housing of another connector is fitted and a locking portion 116 for engaging with a locking piece provided in the housing of another connector to lock a state where the connectors are fitted to each other. Note that a leading end side in the end terminal direction of the fitting hole 113 is formed with a larger diameter via a step portion such that an annular-shaped housing seal 130 is inserted and attached thereto.

The shield shell 120 is made of a metal member formed in a tubular shape in the same manner as the inner ferrule 50 or the outer ferrule 60. Note that a grommet 90 for waterproofing and sealing is attached to a rear side in the end terminal direction of the connector housing 110 to close the opening of the end terminal portion housing hole 112 of the connector housing 110 for covering the end terminal portion of the braided-shield-type electric wire 10.

Next, a method for manufacturing the shield electric wire harness 100 will be described with reference to FIG. 4. First, as illustrated in FIG. 5A, the braided-shield-type electric wire 10 is prepared and is cut at a cutting position which is indicated by, for example, an arrow in the figure (step S100), and as illustrated in FIG. 5B, the sheathing member 11 is removed by cutting at a cut position, which is indicated by an arrow in the figure, by a desired length from the cutting position, at the rear side in the end terminal direction to expose the braided shield member 30 and perform a sheath lead-out. Thus, the direction of the cutting position illustrated in FIG. 5A becomes the end terminal direction.

Next, as illustrated in FIG. 5C, a space is provided between the braided shield member 30 and the sheathed electric wires 20 by loosening the braided shield member 30, and as illustrated in FIG. 5D, the retainer 40 is inserted into the space such that the sheathed electric wires 20 are passed into the terminal insertion holes 41 and each of the sheathed electric wires 20 is held by the retainer 40 (step S102).

Thus, the outer peripheral side of the retainer 40 is surrounded by the braided shield member 30. Then, the leading end in the end terminal direction of the braided shield member 30 is arranged so as to be located at a more front side than the retainer 40 in the end terminal direction (step S104), and subsequently, as illustrated in FIG. 5E, the inner ferrule 50 is arranged at the outer peripheral side of the retainer 40 by inserting the inner ferrule 50 from the leading end side in the end terminal direction such that the braided shield member 30 is sandwiched therebetween (step S106).

At this time, since the inner ferrule 50 is attached such that the engagement holes 51 are engaged with the engagement projection portions 45 of the retainer 40, the braided shield member 30 is temporarily fixed over an entire periphery of the retainer 40 by the inner ferrule 50. After the inner ferrule 50 is arranged, as illustrated in FIG. 5F, the leading end terminal portion in the end terminal direction of the braided shield member 30 is folded toward the rear side in the end terminal direction so as to cover the outer peripheral side of the inner ferrule 50 (step S108).

Next, as illustrated in FIG. 6G, the outer ferrule 60 is arranged at the outer peripheral side of the inner ferrule 50 by inserting the outer ferrule 60 from the leading end side in the end terminal direction such that the braided shield member 30 is sandwiched therebetween (step S110), the inner ferrule 50 and the outer ferrule 60 are crimped by caulking using a caulking tool or the like so as to be deformed into the shape along the recess portion 42 of the retainer 40, and the retainer 40, the braided shield member 30, the inner ferrule 50, and the outer ferrule 60 are fixed (step S112). At this time, since the sheathed electric wires 20 are freely slidable within the electric wire insertion holes 41 of the retainer 40, the end terminal portion of the braided shield member 30 is also relatively formed so as to be freely slide-movable.

After performing the caulking fixation, the wire seal 80 is inserted from the leading end side in the end terminal direction and attached, as illustrated in FIG. 6H, the sheath of each sheathed electric wire 20 is removed and then the core wire 21 is exposed and led-out, and as illustrated in FIG. 6I, the terminal 70 is arranged such that the core wire 21 is located on the crimp portion 72 and the sheathed electric wires 20 are located on the pressing portion 73, and the connection is performed by crimping these wires (step S114).

Subsequently, the shield shell 120 is housed and arranged in the shield shell housing hole 114 of the connector housing 110, the terminal 70 and the end terminal portion of the braided shield member 30 are inserted into the terminal housing hole 111 and the end terminal portion housing hole 112 of the connector housing 110 (step S116), the rib 61 of the outer ferrule is brought into contact with the inner peripheral surface of the shield shell 120 so as to be connected to each other (step S118), and a series of manufacturing steps according to this flowchart is finished.

Note that, prior to the step of holding the sheathed electric wires 20 by the retainer 40 in step S102 described above, for example, the inner ferrule 50 may be inserted to the outer peripheral side of the braided shield member 30 from the leading end side in the end terminal direction so as to be put on standby at the rear side in the end terminal direction, and the braided shield member 30 may be sandwiched between the retainer 40 and the inner ferrule 50 by moving the inner ferrule 50 put on standby to the front side in the end terminal direction at the time of temporarily fixing in step S106 described above.

In addition, instead of the wire seal 80, even though not illustrated in the figures, for example, such a configuration may be adopted that a first seal member is arranged at the outer peripheral side of the tubular portion 44 of the retainer 40, and a second seal member is arranged inside each of the electric wire insertion holes 41, thereby obtaining the same function as the wire seal 80.

As such, according to the connection structure of the braided-shield-type electric wire 10 according to the present embodiment, first, the plurality of sheathed electric wires 20 provided inside the braided shield member 30 is held by the retainer 40, and the braided shield member 30 is sandwiched and temporarily fixed between the retainer 40 and the inner ferrule 50. Subsequently, the braided shield member 30 is folded, and the braided shield member 30 is sandwiched and fixed by caulking between the inner ferrule 50 and the outer ferrule 60, and thus it is possible to suppress the free movement of the sheathed electric wires 20 after the lead-out of the sheath by the retainer 40. At the same time, since the braided shield member 30 is temporarily fixed by the retainer 40 and the inner ferrule 50 before the outer ferrule 60 is mounted, the braided shield member 30 is prevented from being pulled by the sheathed electric wires 20. For this reason, it becomes possible to mount the outer ferrule 60 without taking care of the state of the braided shield member 30, thereby performing the caulking fixation. Accordingly, it is possible to achieve very good workability when the shield electric wire harness 100 is manufactured.

In addition, since the braided shield member 30 is sandwiched and fixed by caulking between the inner ferrule 50 and the outer ferrule 60 in the folded state, the braided shield member 30 is prevented from inadvertently slipping out of the inner ferrule 50 and the outer ferrule 60. Further, since the cut end of the braided shield member 30 is arranged at the rear side in the end terminal direction, the braided shield member 30 is also prevented from being short-circuited by contacting a part of the braided shield member 30 with the terminal 70 or the like. Then, since the retainer 40 is arranged inside the inner ferrule 50, it is possible to allow the retainer 40 to function as a supporting member during the caulking fixation and prevent unnecessary deformation of the overall shapes of the inner ferrule 50 and the outer ferrule 60.

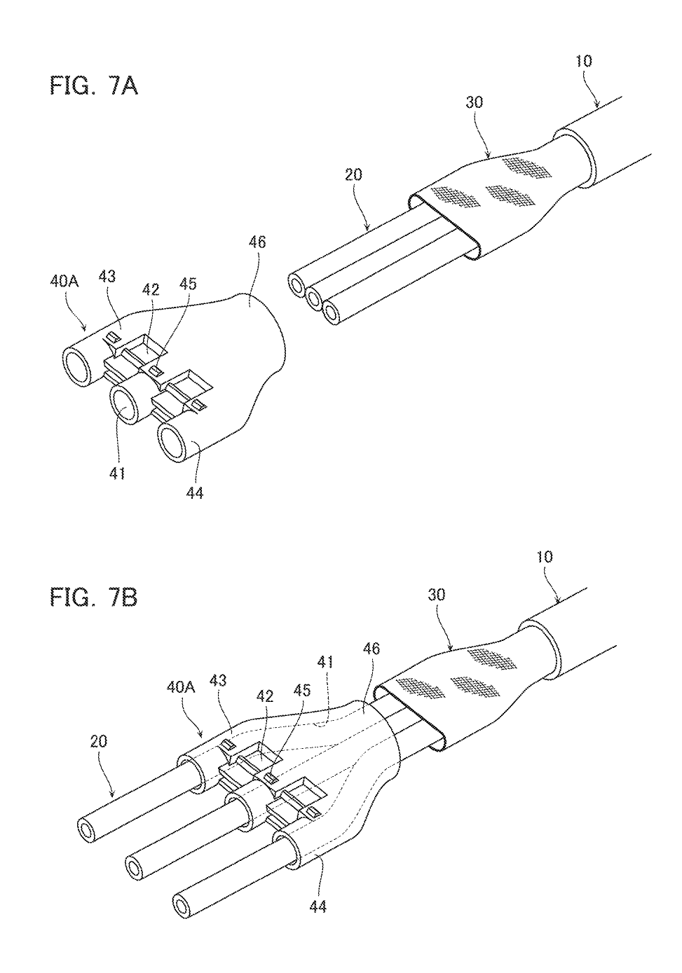

FIGS. 7A and 7B are enlarged perspective views of main portions for illustrating a connection structure of a braided-shield-type electric wire according to another embodiment of the present invention. As illustrated in FIG. 7A, a retainer 40A according to this embodiment is similar to the retainer 40 described above in terms of including a fitting main body portion 43 which is externally fitted to an inner ferrule 50 at an outer peripheral side thereof, and other portions, but is different in terms of further including a tapered portion 46 protruding toward a rear side in an end terminal direction so as to be tapered along an axial direction of a braided-shield-type electric wire 10 from the fitting main body portion 43.

Then, as illustrated in FIG. 7B, electric wire insertion holes 41 are formed along a tubular portion 44, the fitting main body portion 43, and the tapered portion 46 so as to have different arrangement pitches inside the retainer 40A. That is, each electric wire insertion hole 41 is formed such that the arrangement pitch of an opening on the tubular portion 44 and fitting main body portion 43 side becomes wider than the arrangement pitch of an opening on the tapered portion 46 side, in other words, such that the arrangement pitch on the tapered portion 46 side becomes narrower.

Thus, after the lead-out of the sheath, when the retainer 40 is inserted inside the braided shield member 30 from the tapered portion 46 side, the retainer 40 can be easily arranged. In addition, a sheathed electric wire 20 can be also inserted and passed into the electric wire insertion hole 41 without being largely exposed. Thus, it becomes possible to further improve the workability.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A connection structure of a braided-shield-type electric wire for connecting the braided-shield-type electric wire including a plurality of sheathed electric wires and a braided shield member surrounding the sheathed electric wires to a connector and for electrically connecting the braided shield member to a shield shell in a connector housing, the connection structure comprising:
a retainer that is arranged inside the braided shield member to hold the sheathed electric wires in a slidable state;
a first annular conductive member that is fitted to an outer peripheral side of the retainer in a state where the braided shield member is sandwiched therebetween; and
a second annular conductive member that is fitted to an outer peripheral side of the first annular conductive member in a state where the braided shield member is sandwiched therebetween, and
the braided shield member being sandwiched and fixed between the retainer and the first annular conductive member at a position behind a leading end of an end terminal portion and being also sandwiched and fixed by caulking between the first and second annular conductive members after being folded backward from a leading end side of the first annular conductive member.

2. The connection structure of the braided-shield-type electric wire according to claim 1, wherein the shield shell and the second annular conductive member are connected to each other in a state where the end terminal portion of the braided shield member is fitted into the connector housing, and thus the end terminal portion of the braided shield member is electrically connected to the shield shell.

3. The connection structure of the braided-shield-type electric wire according to claim 1, wherein the retainer and the first annular conductive member each include an engaging portion and a portion to be engaged that are engaged with each other.

4. The connection structure of the braided-shield-type electric wire according to claim 1, wherein the retainer has an external shape that is matched to a shape of an annular inner peripheral surface of the first annular conductive member and that has a recess portion formed at a predetermined location, and the first and second annular conductive members are deformed in being matched to the recess portion to be fixed by caulking.

5. The connection structure of the braided-shield-type electric wire according to claim 1, wherein the retainer includes a plurality of electric wire insertion holes into which the plurality sheathed electric wires can be individually inserted.

6. The connection structure of the braided-shield-type electric wire according to claim 5, wherein the retainer includes a plurality of tubular portions that is protruded and formed so as to arrange one sides of openings of the plurality of electric wire insertion holes at the leading end side in the end terminal direction, and
the plurality of tubular portions is housed in terminal housing holes formed in the connector housing, respectively, and also includes a first seal member provided at an outer peripheral side and a second seal member provided in an electric wire insertion hole on an inner peripheral side.

7. The connection structure of the braided-shield-type electric wire according to claim 1, wherein the retainer includes a fitting main body portion that is externally fitted to the first annular conductive member at the outer peripheral side and a tapered portion that protrudes from the fitting main body portion so as to be tapered along an axial direction of the braided-shield-type electric wire.

8. The connection structure of the braided-shield-type electric wire according to claim 7, wherein the plurality of electric wire insertion holes are formed such that an arrangement pitch of an opening on the tapered portion side is narrower than an arrangement pitch of an opening on the fitting main body portion side.

9. A method for manufacturing a shield electric wire harness for connecting a braided-shield-type electric wire including a plurality of sheathed electric wires and a braided shield member surrounding the sheathed electric wires to a connector and for electrically connecting the braided shield member to a shield shell in a connector housing, the method comprising steps of:
cutting the braided-shield-type electric wire so as to expose the braided shield member;
inserting a retainer, in which a plurality of electric wire insertion holes is formed, to outer peripheral sides of the plurality of sheathed electric wires and inside the braided shield member and holding a plurality of sheathed electric wires inserted into the plurality of electric wire insertion holes by the retainer;
surrounding an outer peripheral side of the retainer by the braided shield member and also arranging a leading end in an end terminal direction of the braided shield member at a more front side than the retainer in the end terminal direction;
externally fitting a first annular conductive member to the outer peripheral side of the retainer in a state where the braided shield member is interposed and sandwiching and fixing the braided shield member between the retainer and the first annular conductive member;
folding the leading end in the end terminal direction of the braided shield member which is arranged at the front side in the end terminal direction;
externally fitting a second annular conductive member to an outer peripheral side of the first annular conductive member in a state where the folded braided shield member is interposed, sandwiching and fixing the braided shield member by caulking between the first and second annular conductive members, and forming an end terminal portion of the braided shield member; and
fitting the end terminal portion of the braided shield member to the connector housing and connecting the second annular conductive member to the shield shell after connecting terminal fittings to end terminal portions of the plurality of sheathed electric wires and inserting each of the terminal fittings into the connector housing.

10. The method for manufacturing the shield electric wire harness according to claim 9, comprising a step of mounting the first annular conductive member at an outer peripheral side of the braided shield member so as to be put on standby at a rear side in the end terminal direction, prior to the step of holding the plurality of sheathed electric wires by the retainer,
wherein in the step of sandwiching and fixing the braided shield member, the first annular conductive member being put on standby is moved to a front side in the end terminal direction and is externally fitted to the outer peripheral side of the retainer such that the braided shield member is sandwiched therebetween.
